(19) United States
(12) Patent Application Publication
(10) Pub. No.: US 2009/0060212 A1
(43) Pub. Date: Mar. 5, 2009

(54) MULTI-CHANNEL SWITCH AND TESTING APPARATUS USING THE SAME

(75) Inventors: Yong-Jun DENG, Shenzhen (CN); Geng-Liang ZHANG, Shenzhen (CN); Shih-Fang WONG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD, Tu-Cheng (TW)

(21) Appl. No.: 11/966,995

(22) Filed: Dec. 29, 2007

(30) Foreign Application Priority Data
Aug. 30, 2007 (CN) 200710201538.9

(51) Int. Cl. H04R 29/00

(52) U.S. Cl. 381/58

(57) ABSTRACT

A multi-channel switch for connecting between an electronic apparatus and a testing apparatus comprising: a multi-channel interface for connecting with the electronic apparatus, comprising a plurality of channels; a single-channel interface for connecting with the testing apparatus, comprising one channel; an audio sensor for receiving a sound input, and generating audio signals accordingly; and a controller for receiving the audio signals and establishing a through connection between one of the multi-channel interface and the single channel interface according to the audio signals.

### BACKGROUND

1. Field of the Invention

The present invention generally relates to electronic switches. Particularly, the present invention relates to a multi-channel switch and a testing apparatus using the same.

2. Description of Related Art

Electronic products have various interfaces that include a plurality of channels or a plurality of pins. For example, a video DAC (Digital Analog Converter) interface includes a red I/O channel, a blue I/O channel, and a green I/O channel. The channels of the interfaces must pass functional testing before being distributed.

Referring to FIG. 5, generally, a test system 10 includes a to-be-tested electronic apparatus 12 and a testing apparatus 14. The electronic apparatus 12 has a multi-channel interface 120. The testing apparatus 14 has a single-channel interface 140. A multi-channel interface and a plurality of single-channel interface are on two ends of the cable 16. The cable 16 is used for connecting the multi-channel interface 120 and the single-channel interface 140 respectively. During the test, the cable 16 has to be plugged in and be removed from the single-channel interface 140 repeatedly, which is troublesome and time consuming. Furthermore, the single-channel interface 140 easily breaks after performing the test over an extended period of time.

Consequently, improvements of connections between the cable and the testing apparatus are needed.

### SUMMARY

A multi-channel switch for connecting between an electronic apparatus and a testing apparatus comprising: a multi-channel interface for connecting with the electronic apparatus, comprising a plurality of channels; a single-channel interface for connecting with the testing apparatus, comprising one channel; an audio sensor for receiving a sound input, and generating audio signals accordingly; and a controller for receiving the audio signals and establishing a through connection between one of the multi-channel interface and the single channel interface according to the audio signals.

Other apparatus, features, and advantages of the present multi-channel switch and testing apparatus will be or become apparent to one with skill in the art upon examination of the following drawings and detailed description. It is intended that all such additional apparatus, features, and advantages be included within this description, be within the scope of the present apparatus, and be protected by the accompanying claims.

### BRIEF DESCRIPTION OF THE DRAWINGS

Many aspects of the present apparatus can be better understood with reference to the following drawings. The components in the drawings are not necessary to scale, emphasis instead being placed upon clearly illustrating the principles of the inventive apparatus. Moreover, in the drawings, like reference numerals designate corresponding parts throughout the several views.

FIG. 1 is a schematic diagram of a test system according to an exemplary embodiment, the test system including a multi-channel switch.

FIG. 2 is a block diagram of the multi-channel switch of FIG. 1.

FIG. 3 is a block diagram of the multi-channel switch in accordance with another exemplary embodiment.

FIG. 4 is a schematic diagram of a test system according to another exemplary embodiment.

FIG. 5 is a schematic diagram of a test system of related art.

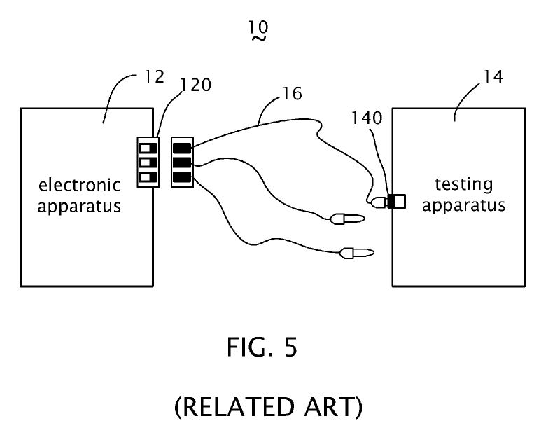

### DETAILED DESCRIPTION OF THE EMBODIMENTS

Reference will now be made to the drawings to describe exemplary and preferred embodiments of the present multi-channel switch and testing apparatus.

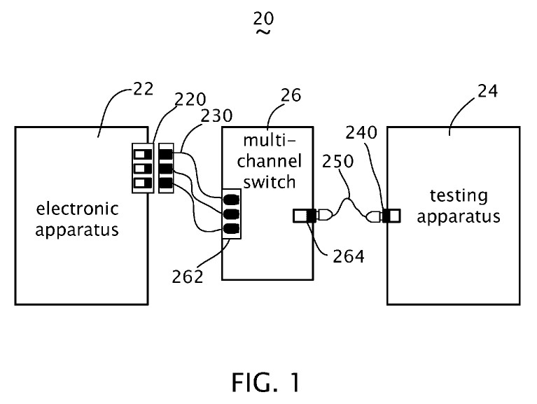

Referring to FIG. 1, a test system 20 includes a to-be-tested electronic apparatus 22, a testing apparatus 24, and a multi-channel switch 26.

The electronic apparatus 22 has a multi-channel interface 220. The testing apparatus 24 has a single-channel interface 240. The multi-channel switch 26 is connected between the multi-channel interface 220 and the single-channel interface 240. The multi-channel switch 26 includes a multi-channel interface 262 and a single-channel interface 264. The multi-channel interface 262 includes a plurality of channels for establishing a plurality of connections with the multi-channel interface 220 of the electronic apparatus 22 via a set of cables 230. The single-channel interface 264 includes one channel for establishing a single channel connection with the single-channel interface 240 of the testing apparatus 24 via a single cable 250.

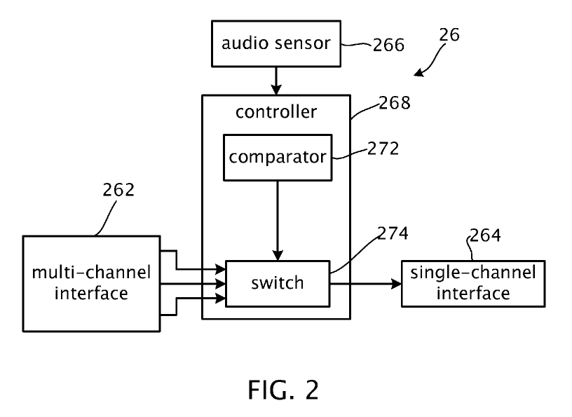

Referring to FIG. 2, a block diagram of the multi-channel switch 26 of FIG. 1 is illustrated. The multi-channel switch 26 further includes an audio sensor 266 and a controller 268.

The audio sensor 266 is used for receiving a sound input, and generating audio signals accordingly. The audio signals can be represented by current signals or voltage signals.

The controller 268 is used for receiving the audio signals and establishing a through connection between one of the multi-channel interface 262 and the single channel interface 264 according to the audio signals. The controller 268 includes a comparator 272 and a switch 274. The comparator 272 is used for comparing the audio signals with a predetermined signal, and generating a control signal according to a comparison result of the comparator 272. The switch 274 is used for enabling the through connection according to the control signal.

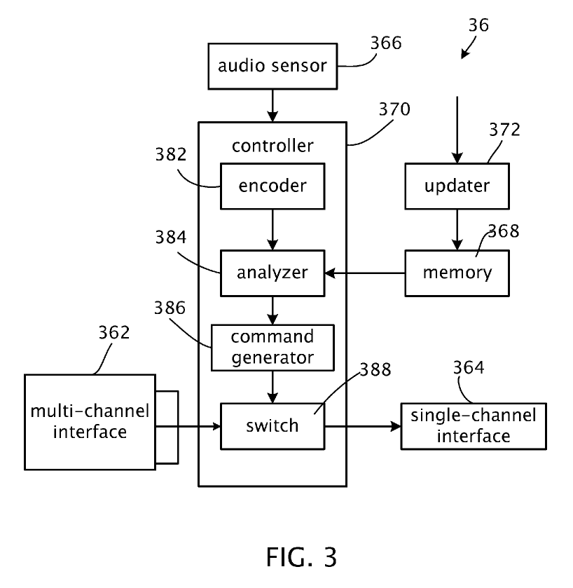

Referring to FIG. 3, a block diagram of the multi-channel switch 36 in accordance with another exemplary embodiment is illustrated. The multi-channel switch 36 includes a multi-channel interface 362, a single-channel interface 364, an audio sensor 366, a memory 368, a controller 370, and an updater 372.

The audio sensor 366 is used for receiving a sound input, and generating audio signals accordingly. The memory 368 is used for storing reference audio data.

The controller 370 is used for comparing the audio signals with the reference audio data, and establishing a through connection between one of the multi-channel interface 362 and the single channel interface 364 according to a comparison result. The controller 370 includes an encoder 382, an analyzer 384, a command generator 386, and a switch 388. The encoder 382 is used for generating audio data according to the audio signals. The analyzer 384 is used for computing whether the audio data matches the reference audio data and generating a control signal according to a computing result. The command generator 386 is used for generating a switching signal according to the control signal, and sending the switching signal to the switch 388. The switch 388 is used for enabling the through connection according to the switching signal.

The updater 372 is used to manually or automatically set or update the reference audio data in the memory 368.

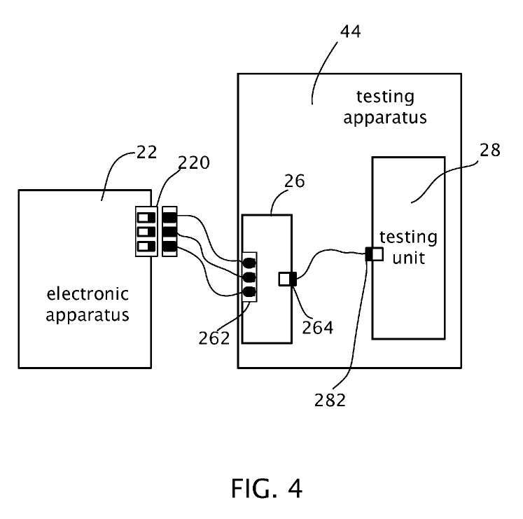

In an other embodiments, the multi-channel switch 26 can be integrated with the testing apparatus 24. Referring to FIG. 4, a testing apparatus 44 in accordance with another embodiment includes the multi-channel switch 26 and a testing unit 28 as FIGS. 1 and 2. The testing unit 28 is used for testing the channels of the multi-channel interface 220 via the multi-channel switch 26. The multi-channel interface 262 of the multi-channel switch 26 is used for establishing a plurality of through connections with the multi-channel interface 220 of the electronic apparatus 22. The single-channel interface 264 of the multi-channel switch 26 is used for establishing a through connection with a single-channel interface 282 of the testing unit 28. In other embodiment, the multi-channel switch included in the testing apparatus 44 can be the multi-channel switch 36 as shown in FIG. 3.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A multi-channel switch for connecting between an electronic apparatus and a testing apparatus comprising:
a multi-channel interface, for connecting with the electronic apparatus, comprising a plurality of channels;
a single-channel interface, for connecting with the testing apparatus, comprising one channel;
an audio sensor for receiving a sound input, and generating audio signals accordingly; and
a controller for receiving the audio signals and establishing a through connection between one of the multi-channel interface and the single channel interface according to the audio signals.

2. The multi-channel switch as claimed in claim 1, wherein the controller comprising:
a comparator for comparing the audio signals with a predetermined signal, and generating a control signal according to a comparison result thereof;
a switch for enabling the through connection according to the control signal.

3. The multi-channel switch as claimed in claim 2, wherein the audio signals are represented by current signals.

4. The multi-channel switch as claimed in claim 2, wherein the audio signals are represented by voltage signals.

5. The multi-channel switch as claimed in claim 1, further comprising a memory for storing reference audio data, and the controller is used for comparing the audio signals with the reference audio data, and establishing a through connection between one of the multi-channel interface and the single channel interface according to a comparison result.

6. The multi-channel switch as claimed in claim 5, wherein the controller comprises:
an encoder for generating audio data according to the audio signals;
an analyzer for computing whether the audio data matches the reference audio data and generating a control signal according to a computing result;
a command generator for generating a switching signal according to the control signal;
a switch for enabling the through connection according to the switching signal.

7. The multi-channel switch as claimed in claim 5, wherein the multi-channel switch further comprising an updater is used to manually or automatically set or update the reference audio data in the memory.

8. A testing apparatus comprising:
a testing unit for testing interfaces of an electronic apparatus;
a multi-channel switch connected to the testing unit, the multi-channel switch comprising:
a multi-channel interface for connecting with the interfaces of the electronic apparatus, comprising a plurality of channels;
a single-channel interface for connecting with the testing unit, comprising one channel;
an audio sensor for receiving a sound input, and generating audio signals accordingly; and
a controller for receiving the audio signals and establishing a through connection between one of the multi-channel interface and the single channel interface according to the audio signals.

9. The testing apparatus as claimed in claim 8, wherein the controller comprising:
a comparator for comparing the audio signals with a predetermined signal, and generating a control signal according to a comparison result thereof;
a switch for enabling the through connection according to the control signal.

10. The testing apparatus as claimed in claim 9, wherein the audio signals are represented by current signals.

11. The testing apparatus as claimed in claim 9, wherein the audio signals are represented by voltage signals.

12. The testing apparatus as claimed in claim 8, further comprising a memory for storing reference audio data, and the controller is used for comparing the audio signals with the reference audio data, and establishing a through connection between one of the multi-channel interface and the single channel interface according to a comparison result.

13. The testing apparatus as claimed in claim 12, wherein the controller comprises:
an encoder for generating audio data according to the audio signals;
an analyzer for computing whether the audio data matches the reference audio data and generating a control signal according to a computing result;
a command generator for generating a switching signal according to the control signal;
a switch for enabling the through connection according to the switching signal.

14. The testing apparatus as claimed in claim 12, wherein the multi-channel switch, further comprising an updater, is used to manually or automatically set or update the reference audio data in the memory.
